(19) United States
(12) Patent Application Publication
(10) Pub. No.: US 2005/0047170 A1
(43) Pub. Date: Mar. 3, 2005

(54) LED heat sink for use with standard socket hole

(75) Inventors: Frances K. Hilburger, Carmel, IN (US); Larry R. Bennett, Shirley, IN (US); Kathryn M. Wehner, Carmel, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation (A Delaware Corporation), Pendleton, IN (US)

(21) Appl. No.: 10/653,367

(22) Filed: Sep. 2, 2003

(51) Int. Cl. B60Q 1/00

(52) U.S. Cl. 362/547

(57) ABSTRACT

A LED light source assembly, utilizing a standard electrical socket with an integrated heat sink and an adjustable secondary heat sink structure is described. The LED light source assembly places a LED light source at a similar relative position inside a lamp housing as a traditional incandescent light bulb, to take advantage of traditional reflector geometries. A heat sink is attached to an automobile electrical socket, having a standard shape for traditional incandescent lighting. A LED light source is installed on the heat sink, and receives electricity from the automobile via the electrical socket. A secondary LED heat sink, with a second LED light source, may optionally be affixed to one of several possible attachment points of the LED light source assembly. The addition of a secondary LED heat sink allows the number and position of LED light sources to be varied according to lighting requirements.

### BACKGROUND

Light emitting diode (“LED”) light sources are desirable for use in the automotive industry because of increased efficiency and longevity over traditional incandescent or arc discharge light sources. The LED offers a better conversion of electricity to emitted light than traditional light sources used in the automotive industry. Given the increased conversion of an LED, a smaller light source and less electricity may be used to fulfill the same lighting requirement as a larger and less efficient incandescent bulb. The use of LED light sources therefore reduces demand on the automobile's alternator and electrical system, which increases the efficiency of the overall automobile. The LED light source is also much more durable and longer lasting than an incandescent or arc discharge lamp. The LED light source, while more efficient than a similar incandescent or arc discharge light source, still produces a great deal of thermal energy as a byproduct of light emission. Therefore, a heat sink may be required to prevent damage to the LED light source over prolonged use.

Modern automobiles utilize an electrical connector and socket arrangement for attaching light sources inside of lamp housings. Examples of automotive lamp housings include headlamps and tail lamps. The connector and socket hole arrangement typically provides a friction fit or a locking mechanism to securely affix the light source into the lamp housing. Automobile manufactures typically utilize one of the many types of standard connector and socket hole arrangements available, to utilize existing light sources in an effort to reduce manufacturing costs. A desirable feature of an LED light source would be the utilization of one or more of these standard connector arrangements, and to position the LED light source similarly to the incandescent light source in the socket hole. Utilizing a standard socket arrangement would allow automobile consumers to replace existing incandescent light sources with LED light sources in an aftermarket setting. Also, manufacturers could simply use LED light sources instead of incandescent light sources, without redesigning an automobile's electrical system.

Thus, desirable features of an LED lamp assembly include attaching a standard connector assembly to the LED, positioning the light source similarly to a comparable incandescent or arc discharge lamp assembly, and including a heat sink to dissipate the heat produced by the LED light source.

### SUMMARY

An LED heat sink assembly comprises a connector base, a first heat sink, and a first light emitting diode. The connector base is dimensioned to fit into one of the many socket hole assemblies available for automobiles. The first heat sink is attached to the connector base. The first heat sink is formed from a thermally conductive material, and comprises a plurality of holes formed by a plurality of ribs, allowing the dissipation of heat away from the first heat sink. The first light emitting diode is attached to the first heat sink, and is in electrical communication with the automobile's electrical system via the connector base. The connector base is adapted to fit any one of the many socket hole assemblies available for automobiles. A second heat sink may be formed with the first heat sink or attached to the heat sink separately. A second light emitting diode is attached to the second heat sink, and is in electrical communication with the automobile's electrical system. The first light emitting diode and the second light emitting diode receive electricity from the automobile's electrical system via the connector base. Light is emitted from the energized light emitting diodes.

In an alternate embodiment, the second heat sink is pivotably attached to the first heat sink, where the pivot may be locked using a screw. The second heat sink may also be releasably attached to the first heat sink, and may be removed or attached as desired.

These and other advantages and features of the present invention shall hereinafter appear, and for the purposes of illustration, but not limitation, exemplary embodiments of the present invention shall hereinafter be described.

### BRIEF DESCRIPTION OF THE DRAWINGS

FIG. 1 is a side view of an LED heat sink assembly;

FIG. 2 is a side view of the first heat assembly of the LED heat sink assembly in FIG. 1;

FIG. 3 is a side view of the second heat sink assembly of the LED heat sink assembly in FIG. 1; and

FIG. 4 is a side view of the LED heat sink assembly in FIG. 1 and a automobile socket connection.

### DETAILED DESCRIPTION

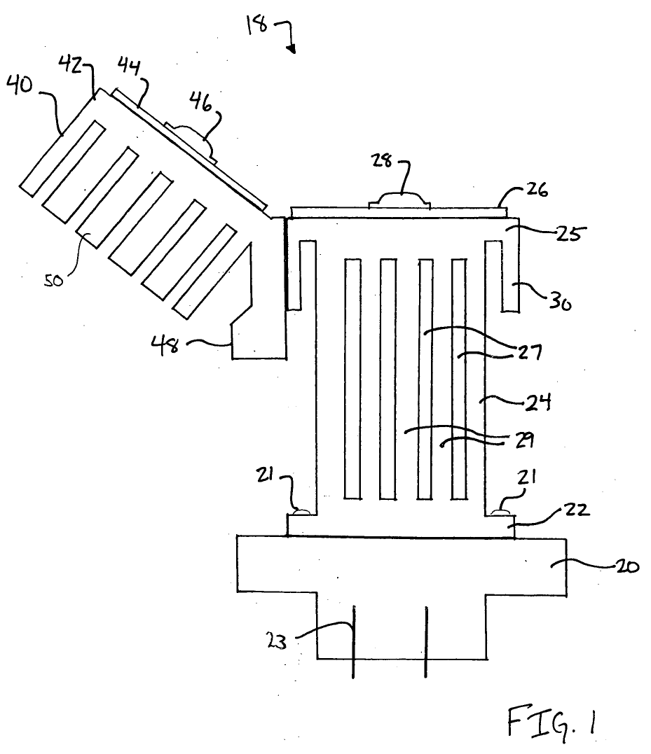

One embodiment of a LED heat sink assembly is provided as shown in FIG. 1, and is generally indicated as numeral 18. The LED heat sink assembly 18 comprises an electrical connector element 20, a heat sink 24, an LED light source 28, and a LED attachment plate 26. The heat sink includes a heat sink base 22, a plurality of ribs 29, and a heat sink plate 25. A second heat sink assembly 50 may also be attached to the first heat sink assembly 18. The second heat sink assembly 50 comprises a second LED light source 46 and a second heat sink 40, including a second heat sink plate 42, and a second LED attachment plate 44. The heat sink and/or heat sink assembly may also be referenced herein as the thermal transfer device.

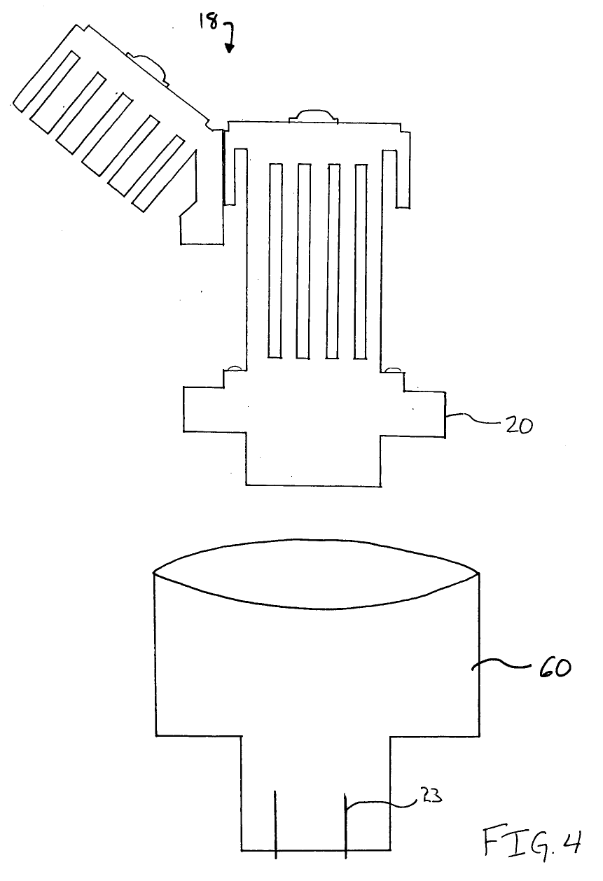

The connector element 20 provides an electrical attachment point to the automobile's electrical system, and is designed to fit into a standard automotive lamp socket 60 (see FIG. 4). The concept of an electrical connector element and socket is well understood and practiced in the art. The connector element 20 may be of any type known in the art, for example, a wedge base or a bayonet base, including electrical leads 23 (including terminals) as traditionally used for connecting and securing a light bulb to a bulb socket and lamp housing. The electrical connector element 20 shown in FIG. 1 may optionally contain a circuit and associated circuitry in order to alter the characteristics of the electricity generated by the automobile into an appropriate form for use by LED light sources. For example, the voltage and electric current may be altered by a transformer, or resistance may be added to the circuit to current reduce flow so that the LED light sources are not overloaded by an inappropriate current.

The heat sink 24 is attached to the electrical connector element 20, and is formed from a rigid thermally conductive material, such as aluminum. Fasteners 21 are inserted into overlapping openings in the heat sink base 22 and the electrical connector element 20, to secure the heat sink 24 to the electrical connector element 20. The heat sink 24 may be constructed with openings 27 therethrough, to facilitate the transfer of beat from the heat sink to the surrounding atmosphere. The openings 27 are formed by the plurality of ribs 29 that form heat dissipating surfaces for the heat sink. It should be noted that any pattern of openings in the heat sink 24 may be used, as known in the art. The openings in the heat sink 24, as well as the dimensions and material used, may vary depending on use, in order to optimize heat transfer to the surrounding atmosphere and to optimally position the LED light source 28 inside of the lamp 0housing (not shown). The heat sink attachment plate 25 is also formed from a rigid thermally conductive material, and is attached to the ribs of the heat sink 24. The heat sink base 22, ribs 29 and plate 25 may all be a single integral piece, or may be constructed as multiple connected pieces.

The LED attachment plate 26 is also formed from a rigid thermally conductive material, and is attached in thermal communication with the heat sink attachment plate 25. The heat sink 24 and the LED attachment plate 26 may all be formed as a single component, or they may be formed separately, and attached together by welding or any other means known in the art. If the above components are formed separately, a thermally conductive paste may be used to enhance heat transfer between the components. The LED attachment plate 26 contains an opening which serves as an attachment point for one or more LED light sources 28.

The LED light source 28 is attached to the LED attachment plate 26, and is in electrical communication with the automobile's electrical system via wires (not shown) extending from the electrical connector element 20, through or along the heat sink 24, and into the leads to the LED provided on the LED attachment plate 26. The LED light source 28 may be formed from any combination of materials, such that it may emit light of any color, as is known in the art. The LED light source 28 may also be operable to emit light of any intensity, as different automobile lighting requirements may necessitate that the LED light source or light sources be of a specific intensity or in a specific range of intensities.

For some automotive lighting applications, additional lighting may be required or desired, or an alternate light source position may be desired. Such an addition may be made by attaching a second heat sink assembly 50 to the attachment plate 25, as described below and as shown in FIG. 1. The second heat sink assembly 50 is comprised of a second heat sink 40 having an attachment point 48, a second LED attachment plate 44, and a second LED light source 46. The second heat sink 40, and the second LED attachment plate 44 are formed from a thermally conductive material, and may optionally be formed as a single component, or may be formed separately and attached together during manufacture. Optionally, the second heat sink assembly 50 may be formed integrally with the heat sink components of the first assembly 22, 24, 25, and 26. The second heat sink 40 is made of a thermally conductive material, and may be constructed with openings therethrough, to facilitate the transfer of heat from the heat sink 40 to the surrounding atmosphere. Of course, as with the first heat sink 24 described above, any pattern of openings may be used to achieve the desired level of heat transfer to the surrounding atmosphere. The second heat sink assembly 50 is attached to the first heat sink 24 by means commonly known in the art, if the second heat sink assembly 50 is not integrally formed with the heat sink components of the first assembly 22, 24, 25, and 26. The second LED attachment plate 44 contains a connection for the attachment of a second LED light source 46. The second LED light source 46 may have the same physical and operational characteristics as the LED light source 28 described above, or may have dissimilar characteristics, such as overall color of emitted light or intensity, where it may be desirable to have the combination of two light sources with different characteristics. Similar to the first LED 28, The second LED light source 46 is in electrical communication with the automobile's electrical system via wires (not shown) extending to the electrical connector element 20.

In one alternate embodiment, the attachment point 48 may be provided as a hinged joint that may be locked in place by rotation of a screw (not shown) in an adjustment hole (not shown) provided on the attachment point. When the screw is loosened, the LEDs may be adjusted relative to each other within the lamp assembly.

In another alternate embodiment, the attachment point 48 may be provided as a detachable structure, so that the second heat sink assembly 50 may be attached or detached as desired. The two structures may be affixed to each other by the use of a screw (not shown).

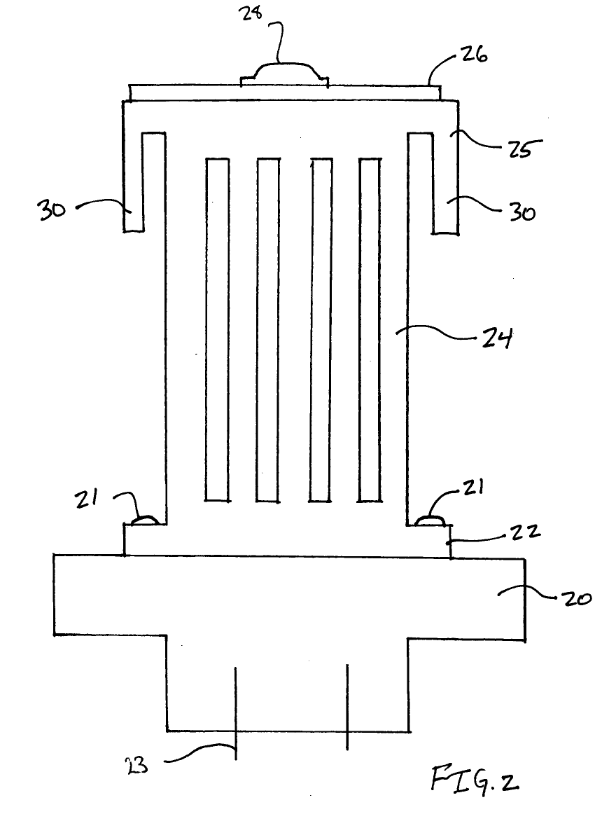

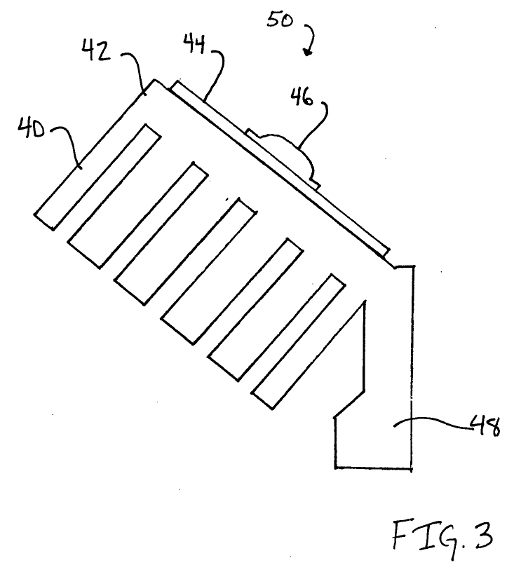

Operation of the disclosed embodiment of a LED heat sink assembly 18 is now described in FIGS. 1-4. The electrical connector element 20 is inserted into a socket connection 60 on the automobile. The method of attachment depends on the style of electrical connector and socket used in the present invention. A wedge base is well known in the art, and comprises a tapered, rectangular section and metallic elements, or leads, positioned at the sides of the rectangular section. If a wedge base style of electrical connector is used, the wedge base is inserted into the wedge socket on the automobile. The wedge socket also contains metallic elements, or terminals, for forming an electrical communication between the LED assembly 18 and the electrical system of the automobile. A friction fit is formed between the wedge base and the wedge socket, and electrical communication is enabled between the leads on the wedge base and the terminals on the wedge socket. Similarly, a bayonet connector, also well known in the art, comprises an essentially cylindrical connector base, two projections extending radially from the connector base, and leads positioned at the sides and bottom of the connector base, to establish electrical communication with the vehicle. A bayonet socket comprises a cavity with two J-shaped grooves along the inside of the cavity, and terminals on the side and bottom of the cavity, where the metallic elements are in electrical communication with the vehicle's electrical system. The bayonet connector is inserted into the cavity of the bayonet socket such that the two projections are inserted into the two grooves. The bayonet socket is then turned to lock the projections into the grooves. The leads of the bayonet connector and the terminals of the bayonet socket are in communication, to deliver electricity from the automobile's electrical system to the connector.

Once installed in the automobile, the LED heat sink assembly 18 may be selectively energized. Energizing the LED heat sink assembly 18 transmits electricity to the LED light source 28 and the second LED light source 46, if a second heat sink assembly 50 is attached. The energized LED light sources 28 and 46 then emit light into the lamp housing (not shown). The use of the second heat sink assembly 50 allows additional lighting, and the first and second heat sinks 24 and 40 allow heat produced by the first and second LED light sources 28 and 46 to be transferred away from the assembly, an important function required for prolonged use.

As can be readily seen, utilization of the present invention allows a LED light source to be used as a replacement for an incandescent lamp in automobile lighting applications. Thus, utilizing the present invention with an automobile decreases the electrical demands and increases the useful life of the lamp, while still utilizing the original geometry of the lamp reflector, and also providing thermal dissipation for the light source.

Although other advantages may be found and realized and various modifications may be suggested by those versed in the art, it is understood that the present invention is not to be limited to the details given above, but rather may be modified within the scope of the appended claims.

1. A heat sink assembly adopted for use in a standard automotive bulb socket comprising:
a. a base arranged and dimensioned to fit within the standard automotive bulb socket, the base including leads to provide electric communication between the socket and the base;
b. a heat sink attached to the base and extending from the socket; and
c. a light emitting diode attached to the heat sink, the light emitting diode in electrical communication with the base.

2. An assembly as in claim 1, where the heat sink comprises a first end and a second end, wherein the first end is attached to the base and the second end is attached to the light emitting diode, and a plurality of ribs extends between the first end and the second end.

3. An assembly as in claim 1, where the assembly further comprises a second assembly attached to the heat sink, the second assembly comprising:
a. a second heat sink; and
b. a second light emitting diode attached to the second heat sink.

4. An assembly as in claim 3, where the second light emitting diode is in electrical communication with the base.

5. The heat sink assembly as in claim 3, where the light emitting diode and the second light emitting diode emit light of different colors.

6. The heat sink assembly as in claim 3, where the second assembly is releasably attached to the heat sink.

7. The heat sink assembly as in claim 3, where the second assembly is pivotably attached to the heat sink.

8. A heat sink assembly adopted for use in a standard automotive bulb socket comprising:
a. a base arranged and dimensioned to fit within the standard automotive bulb socket and provide electric communication between the socket and the assembly;
b. a first thermal transfer device attached to the base and extending from the socket, the thermal transfer device comprising a first end and a second end, wherein the first end is attached to the base;
c. a first light emitting diode attached to the first thermal transfer device, the light emitting diode in electrical communication with the base;
d. a second thermal transfer device attached to the first thermal transfer device; and
e. a second light emitting diode attached to the second thermal transfer device.

9. The heat sink assembly as in claim 8, where the second thermal transfer device is releasably attached to the first thermal transfer device.

10. The heat sink assembly as in claim 8, where the second thermal transfer device is pivotably attached to the first thermal transfer device.

11. An assembly as in claim 8, where the second light emitting diode is in electrical communication with the base.
